(19) United States
(12) Patent Application Publication
(10) Pub. No.: US 2026/0099772 A1
(43) Pub. Date: Apr. 9, 2026

(54) LARGE LANGUAGE MODEL UNLEARNING VIA LOSS ADJUSTMENTS

(71) Applicant: ACCENTURE GLOBAL SOLUTIONS LIMITED, Dublin 4 (IE)

(72) Inventors: Jinlong PANG, Mountain View, CA (US); Jiaheng WEI, Santa Clara, CA (US); Ankit Parag SHAH, Mountain View, CA (US); Yujia BAO, Cambridge, MA (US); Yaxuan WANG, Mountain View, CA (US); Wei WEI, Burlingame, CA (US); Yang LIU, Santa Cruz, CA (US); Quan LIU, Mountain View, CA (US); Yuhao LIU, Santa Cruz, CA (US)

(73) Assignee: ACCENTURE GLOBAL SOLUTIONS LIMITED, Dublin 4 (IE)

(21) Appl. No.: 19/347,258

(22) Filed: Oct. 1, 2025

Related U.S. Application Data
(60) Provisional application No. 63/702,965, filed on Oct. 3, 2024.

(51) Int. Cl. G06N 20/00

(52) U.S. Cl. CPC G06N 20/00

(57) ABSTRACT

System and method for LLM unlearning via loss adjustments are disclosed. The method includes accessing forget data samples from one or more datasets, associating a template response for each forget data sample via implementation of one or more LLMs, and training a target LLM using a forget data only loss adjustment (FLAT) function to generate an unlearned LLM, including implementing a loss adjustment to maximize a divergence for between an available template answer and a forget answer only with respect to forget data samples.

### CROSS-REFERENCE TO RELATED PATENT APPLICATIONS

This application claims priority to U.S. Provisional Application No. 63/702,965, filed on Oct. 3, 2024, the entire content of which is hereby incorporated by reference in the entirety for all purposes.

### TECHNICAL FIELD

The present disclosure generally relates to the field of large language models and, more particularly, to a system and a method for large language model unlearning via loss adjustments.

### BACKGROUND

Large Language Model (LLM) unlearning is a process of making an LLM forget specific information, behaviors, or patterns it has previously learned. Unlearning is essential for ensuring ethical and responsible use of Artificial Intelligence (AI) systems, especially in addressing privacy leaks, bias, safety, and evolving regulations. Existing approaches to unlearning in Large Language Models (LLMs) often rely on the use of retain data (information the model should continue to remember) or a reference LLM (a separate model that still retains the original knowledge). These components help guide the unlearning process by contrasting what should be forgotten with what should be preserved.

However, the existing methods face significant challenges. For example, the methods struggle to effectively balance the need to remove specific knowledge with the need to maintain the overall performance and usefulness of the model. This difficulty arises because the process of using retain data, either directly or indirectly, during fine-tuning often unintentionally causes an overlap between the information meant to be forgotten and the information meant to be retained. Hence, even after unlearning, the model may still generate responses to certain queries that closely resemble its previous behavior. This may occur because different prompts often trigger similar underlying representations, making it hard to isolate and erase only the targeted knowledge. As a result, the boundary between what the model forgets and what the model remembers becomes blurred, reducing the effectiveness and reliability of the unlearning process.

### SUMMARY

This summary is provided to introduce a selection of concepts in a simple manner that is further described in the detailed description of the disclosure. This summary is not intended to identify key or essential inventive concepts of the subject matter, nor is it intended for determining the scope of the disclosure.

System and method for LLM unlearning via loss adjustments are disclosed. The method includes accessing forget data samples from one or more datasets, associating a template response for each forget data sample via implementation of one or more LLMs, and training a target LLM using a forget data only loss adjustment (FLAT) function to generate an unlearned LLM, including implementing a loss adjustment to maximize a divergence for between an available template answer and a forget answer only with respect to forget data samples.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure is not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 depicts an example environment including a system LLM unlearning, in accordance with an embodiment of the present disclosure;

FIG. 2 depicts a block diagram of the system, in accordance with an embodiment of the present disclosure;

FIG. 3 is a flowchart illustrating a method of LLM unlearning, in accordance with an embodiment of the present disclosure; and

FIG. 4 illustrates a computer system that may be used to implement the system disclosed in the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/act involved.

Specific details are provided in the following description to provide a thorough understanding of embodiments. However, it will be understood by one of the ordinary skills in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

To address the one or more limitations described in the background, embodiments of the present disclosure describe a system and method for LLM unlearning via loss adjustments are disclosed. Unlearning as described herein refers to a process of making an LLM forget specific information (for example, trained or learnt information) using forget data samples and a Forget data only Loss Adjustment (FLAT) function. The information may include, but is not limited to, privacy related information (for example, personal or sensitive data that was intentionally or unintentionally included while training an LLM), legal compliance data, confidential information of companies and organizations, safety information and information that needs to be forgotten, outdated information or incorrect facts. In an embodiment, the system receives forget data samples from one or more datasets and associates a template response for each forget data sample using one or more LLMs. Then the system trains a target LLM (which needs to be unlearned) using a forget data only loss adjustment (FLAT) function to generate an unlearned LLM. Hence, the proposed system and method guides the target LLM on what not to respond to, and importantly, how to respond, based on the forget data samples.

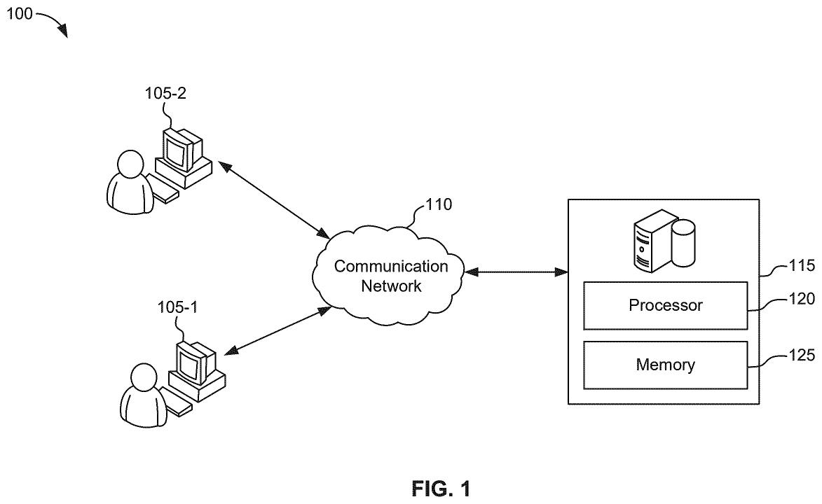

FIG. 1 depicts an example environment including a system for LLM unlearning, in accordance with an embodiment of the present disclosure. As shown, environment 100 includes one or more data sources (shown only two data sources 105-1 and 105-2), a communication network 110 and a system 115, wherein the one or more data sources 105 and the system 115 are communicatively connected over the communication network 110.

The data sources may include a server, and a combination of servers. The data sources 105 may present one or more user interfaces (e.g., Graphical User Interfaces (GUIs)) of a workspace for the user to interact with the system 115. In an embodiment of the present disclosure, the data sources include data samples having forget data samples. The term forget data samples as described herein refers to the data that needs to be unlearned by the LLM. Hence the forget data samples may include privacy related data (personal or sensitive data that was intentionally or unintentionally included while training an LLM), legal compliance data, confidential information of companies and organizations, safety information and any information that needs to be forgotten, outdated information or incorrect facts. Such data samples retrieved from the trained data set of the LLM, original sources, using automated query generation and adversarial prompting. Further, the data samples may be extracted using model usage logs, flagged outputs, or user feedback. Such samples are stored in the data sources 105 in any of the know formats such as, word, text file, PDF, database entries, etc. The data sources 105 may be used to provide input and/or receive output to/from the system 115. The input or the input data may include the forget data samples.

In some examples, the communication network 110 includes a Local Area Network (LAN), a Wide Area Network (WAN), the Internet, or a combination thereof, and connects plurality of data sources 105 and the system 115. In some examples, the communication network 110 may be accessed over a wired and/or a wireless communication link. For example, a computing device like smartphone may utilize a cellular network to access the communication network 110.

In an embodiment, the system 115 may be implemented as an on-premises system that is operated by an enterprise or a third-party engaged in cross-platform interactions and data management. In some examples, the system 115 may be implemented as an off-premises system (for example, cloud or on-demand) that is operated by an enterprise or a third-party on behalf of an enterprise. In some examples, the system 115 may be implemented in a cloud environment. For simplicity, the system 115 depicted in FIG. 1 may be a cloud environment that is intended to represent various forms of servers including a web server, an application server, a proxy server, a network server, a server pool, and/or the like.

In some examples, the system 115 may be implemented by way of a single device or a combination of multiple devices that may be operatively connected or networked together. The system 115 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, two or more lines of code, or other suitable software structures operating in one or more software applications. Referring to FIG. 1, the system 115 includes a processor 120 and a memory 125 communicably coupled to the processor 120. The processor 120 may include one or more processors. Examples of the processor 120 may include, but are not limited to, microprocessors, microcomputers, microcontrollers, digital signal processors, central processing units, state machines, logic circuits, and/or any devices that manipulate data or signals based on operational instructions. Among other capabilities, the processor 120 may fetch instructions (also be referenced to as processor-executable instructions or machine-executable instructions) from the memory 125 and execute the fetched instructions for performing operations according to the present disclosure. The memory 125 may be non-volatile or non-transitory computer-readable medium (CRM) such as, a magnetic disk or solid-state non-volatile memory or volatile medium such as Random Access Memory (RAM), and/or the like.

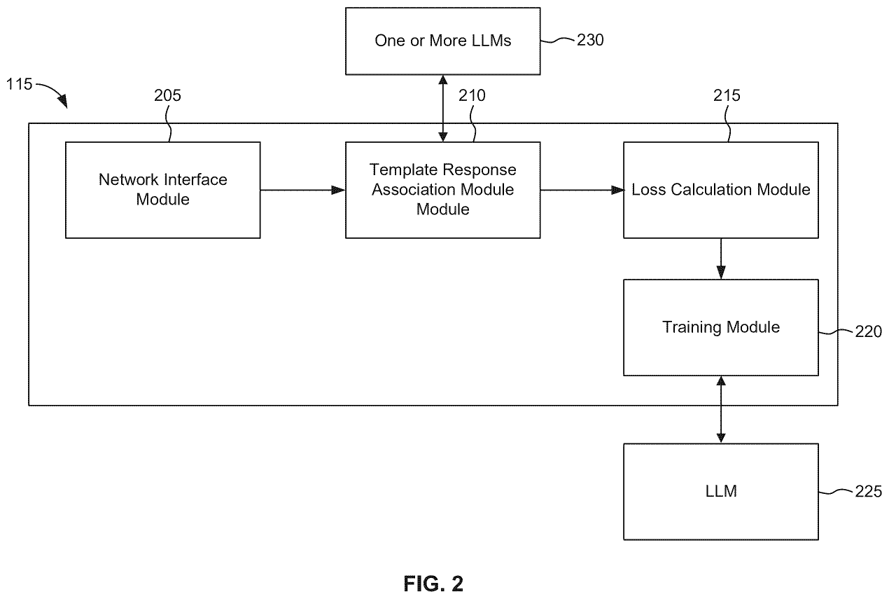

FIG. 2 depicts a block diagram of the system, in accordance with an embodiment of the present disclosure. As shown, in addition to the processor 120 and the memory 125, the system 115 includes a network interface module 205 enabling communication between the system 115 and the plurality of data sources 105, a template response association module 210, a loss calculation module 215 and a training module 220, wherein the training module 220 is configured to train a target LLM 225 which needs to be unlearned.

As described, the system 115 is configured to fine-tune the target LLM 225 using the forget data samples in order to unlearn specific information. In an embodiment of the present disclosure, upon receiving the forget data samples, the template response association module 210 obtains a template response for each forget data sample using one or more LLMs 230. That is, the template response association module 210 generates a query, using the forget data samples, for the one or more LLM 230 to obtain a template response (example response) for each data sample.

Considering a set of forget data samples (x_{f}, y_{f})∈D_{f}, wherein x_{f} denotes the forget data sample and y_{f} denotes the original response to the corresponding forget data sample, the template response association module 210 may generate a template response yₑ for each forget data sample x_{f}. Together these may be denoted as a paired samples

$${\{ ( {x}_{f}^{j} , {y}_{e}^{j} ) \}}_{j ∈ [ N ]} \qquad Equation ( 1 )$$

In an embodiment, the template response is generated using the one or more LLMs 230, which may be open source LLMs. In another embodiment, the template response may be defined by a user. The template response is an unlearning response and may be rejected based answer such as “I don't know”, “I don't have information on that” or an irrelevant answer devoid of the unlearning target-related information. Hence the template response association module 210 may generate example responses for fine-tuning the target LLM 225 and provide better instructions regarding what the target LLM 225 should respond given the forget data as the input.

Upon associating a template response for each forget data sample, the loss calculation module 215 may calculate a loss and perform FLAT loss adjustment. In some examples, the FLAT loss adjustment may adjust the loss function using only the forget data sample by leveraging f-divergence maximization towards the distance between the template response (a preferred template) and original forget responses (the original responses from the target LLM with the forget data samples). That is, in some examples, the loss calculation module 215 may compute divergence between the template response and the original responses that the target LLM 225 used to give. If the divergence is small (for example, within a predefined threshold), then the response may be deemed undesirable or bad. Also, if the divergence is high, then the response may be deemed desirable or good. During training of the target LLM 230, the divergence may be maximized and the target LLM 230 is may be trained to provide response that may be different from what it may be used to respond with the forget data. That is, the system may train the target LLM 225 to move away from the response to make a new response which is different. This process is repeated until the target LLM 225 gives a different (for example, a generic or uninformative) response to the forget data samples.

In an embodiment, the loss adjustments with respect to the sample pairs (x_{f}, yₑ, y_{f}) is performed as:

$$L ( {x}_{f} , {y}_{e} , {y}_{f} ; θ ) = {λ}_{e} \cdot {L}_{e} ( {x}_{f} , {y}_{e} ; θ ) - {λ}_{e} \cdot {L}_{f} ( {x}_{f} , {y}_{f} ; θ ) \qquad Equation ( 2 )$$

wherein Lₑ and L_{f} are losses designed for the data sample (x_{f}, yₑ) and (x_{f}, y_{f}) respectively. Specifically, Lₑ denotes loss (also referred to as importance weight) when the target LLM gives a new response, and L_{f} denotes the loss when the target LLM gives the original answer. Training the target LLM 230 using loss adjustment method enables the target LLM 230 to forget the forget data samples with bad responses, and to learn to generate good responses on relevant forget data, wherein the good responses may be the template responses.

It should be noted that the method leverages f-divergence to illustrate the appropriate balancing between Lₑ(x_{f}, yₑ; θ) and L_{f}(x_{f}, y_{f}; θ). Considering that (x_{f}, yₑ) is given by X_{f}, Yₑ jointly following the distribution Dₑ, wherein Dₑ (that is, the first distribution) is the distribution where the forget samples are paired with the new template responses and represents the LLM 230 after forgetting. Similarly, (x_{f}, y_{f}) is given by X_{f}, Yₑ jointly following the distribution D_{f}, wherein D_{f} (that is, the second distribution) is the distribution where the forget samples are paired with the original responses, that is what the LLM 230 is learned before forgetting. The target LLM's original behavior on forget data samples ((D_{f})) is compared with the unlearned behavior ((Dₑ)), and f-divergence (f_{div}(Dₑ∥D_{f})) between these two distributions are maximized to make the target LLM's new behavior as different as possible from its old behavior with regard to the forget data samples.

As described, in some examples, the system receives forget data samples as input, determines and associates a template response (a new response) for each data sample using one or more LLMs, computes and adjusts the loss by maximizing the divergence, and then trains the target LLM to generate good responses (that is, template responses) on relevant forget data.

In an embodiment, a variational form f-divergence may be implemented. Instead of optimizing the f_{div} term directly, a variational form of it may be derived as follows:

$${f}_{div} ( {𝒟}_{e} \vert ) = {sup}_{g} [ {E}_{{𝒵}_{e} ∼ {𝒟}_{e}} [ g ( {𝒵}_{e} ) ] - [ {f}^{*} ( g ( ) ) ] ] := {sup}_{g} VA ( θ , g ) , \qquad Equation ( 3 )$$

wherein f* is defined as the conjugate function of the f-divergence function. Here, [symbol] is drawn from template data pairs distribution and [symbol] [g( [symbol] )] estimates the “loss” between the model's response to x_{f} and the target yₑ. This corresponds to the discrepancy between θ(x_{f}) and yₑ, where θ(x_{f}) represents the answer generated by the target LLM parameterized by θ given the prompt x_{f}. Similarly, [symbol] estimates the loss for (x_{f}, y_{f}; θ). A function

$$VA ( θ , {g}^{*} ) := {sup}_{g} VA ( θ , g )$$

may be defined wherein g* is the optimal variational function. Hence, the object of FLAT is to obtain: θ*:=arg max θVA(θ, g*).

In some instances, Equation (3) could be viewed as a data distribution level loss adjustment, in practice, when given access to a set of forget data as well as example and bad answers, x_{f}, yₑ, y_{f}, the per-sample loss function (closed form of Equation (2)) may be provided as follows:

$$L ( {x}_{f} , {y}_{e} , {y}_{f} ; θ ) = - [ {sup}_{g} ( g ( P ( {x}_{f} , {y}_{e} ; θ ) ) - {f}^{*} ( g ( P ( {x}_{f} , {y}_{f} ; θ ) ) ) ) ] = - {g}^{*} ( P ( {x}_{f} , {y}_{e} ; θ ) ) + {f}^{*} ( {g}^{*} ( P ( {x}_{f} , {y}_{f} ; θ ) ) ) \qquad Equation ( 4 )$$

In some examples, the above equation may implement a custom loss function which tries to penalize the model when the model makes similar predictions for a correct response and an undesired response. This loss measures how distinguishable the model's prediction for the correct response yₑ is from the prediction for the bad response y_{f} using an f-divergence. If the model gives higher confidence to the correct response yₑ, then the loss will be low. If the model gives similar scores to both the responses, the loss becomes high. The form of loss is governed by the choice of divergence, through f and f*.

As described herein, the systems and methods described herein may implement FLAT technique which uses the variational form of an f-divergence to define a loss adjustment that implicitly gives different importance weights to the template and forgetting responses, using only forget data samples. The proposed method assigns different importance weights for the learning with respect to the template responses and the forgetting of responses subject to unlearning via the variational (f-divergence) form. During training, the target LLMs loss function is adjusted to increase the loss on the forget data, while maintaining the original loss on the remaining training data. This encourages the model to down weight the importance of the forget data in its learned representations.

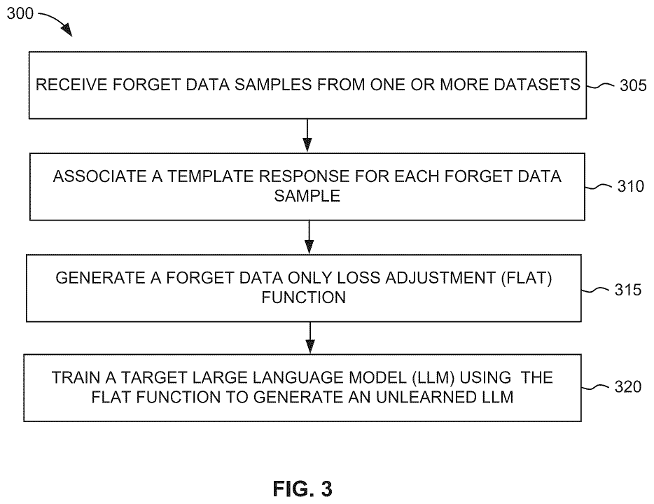

FIG. 3 is a flowchart illustrating a method of LLM unlearning, in accordance with an embodiment of the present disclosure. As shown at step 305, initially the system 115 receives forget data samples from one or more data sets stored in the one or more data sources. The term “forget data” samples as described herein may refer to the data that needs to be unlearned by the LLM. Hence the forget data samples may include privacy related data (personal or sensitive data that was intentionally or unintentionally included while training an LLM), legal compliance data, confidential information of companies and organizations, safety information and any information that needs to be forgotten, outdated information or incorrect facts. Such data samples retrieved from the trained data set of the LLM, original sources, using automated query generation and adversarial prompting. Further, these data samples may be extracted using model usage logs, flagged outputs, or user feedback. Such samples are stored in the data sources 105 in any of the know formats such as, word, text file, PDF, database entries, etc.

Upon receiving the forget data samples, the system 115 associates a template response for each forget data sample as shown at step 310. In an embodiment, the system 115 uses one or more LLMs to associate a template response for each forget data samples, as described with reference to template response association module 210 of FIG. 2.

At step 320, the system 115 generates a forget only loss adjustment (FLAT) function to provide a loss adjustment to maximize a divergence for between an available template answer and a forget answer only with respect to forget data samples. The FLAT function adjusts the loss function using only the forget data sample and by leveraging f-divergence maximization towards the distance between the template response (a preferred template) and original forget responses (the original responses from the target LLM with the forget data samples). That is, the loss calculation module 215 computes divergence between the template response with the original responses that the target LLM 225 used to give. If the divergence is small (within a predefined threshold), then the response is bad and if the divergence is high, then the response is good.

At step 320, the system 115 trains of the target LLM 230 and during training the divergence is maximized and the target LLM 230 is trained to provide response which is different from what it used to respond with the forget data. That is, the system trains the target LLM 225 to move away from the response to make a new response which is different. This process may be repeated until the target LLM 225 gives a different (a generic or uninformative) response to the forget data samples. The training as described herein includes updating node content and embedding vectors of the target LLM. Hence, the system causes the target LLM to forget unlearned data samples with bad responses and generate good responses for unlearned data samples.

As described, the system and method implemented with FLAT loss adjustment approach maximizes f-divergence between the available template answer and the forget answer only with respect to the forget data. In some examples, the variational form of the defined f-divergence provides a way of loss adjustment by assigning different importance weights for the learning with respect to template responses and the forgetting of responses subject to unlearning. In some instances, empirical results may demonstrate that these approaches not only achieves superior unlearning performance compared to existing methods but also minimizes the impact on the model's retained capabilities, thereby ensuring high utility across diverse tasks, including copyrighted content unlearning and entity unlearning on the dataset.

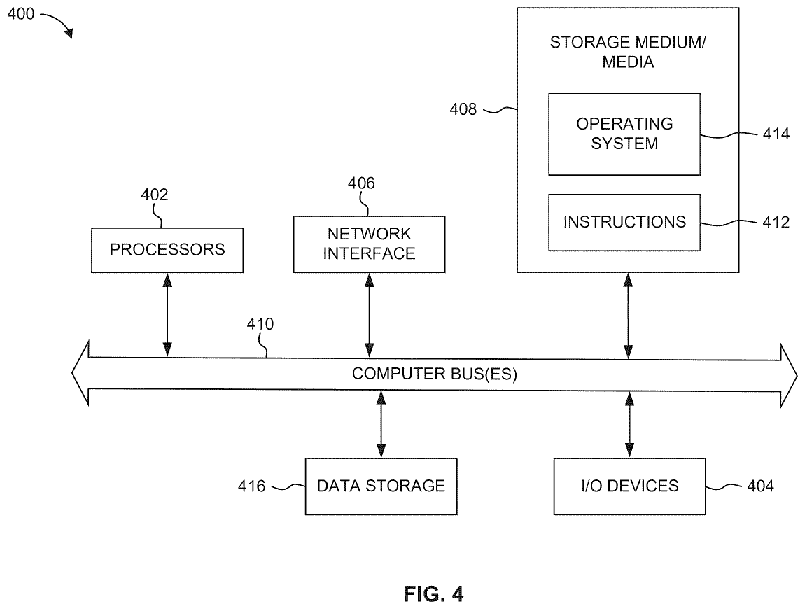

FIG. 4 illustrates a computer system that may be used to implement the system disclosed in the present disclosure. The computer system 400 may include additional components not shown and that some of the process components described may be removed and/or modified. In another example, a computer system 400 may be deployed on external-cloud platforms such as cloud, internal corporate cloud computing clusters, organizational computing resources, and/or the like.

The computer system 400 includes processor(s) 402, such as a central processing unit, ASIC or another type of processing circuit, input/output devices 404, such as a display, mouse keyboard, etc., a network interface 406, such as a Local Area Network (LAN), a wireless 902.11x LAN, a 3G or 4G mobile WAN or a WiMax WAN, and a processor-readable medium 408. Each of these components may be operatively coupled to a bus 410.

The computer-readable medium 408 may be any suitable medium that participates in providing instructions to the processor(s) 402 for execution. For example, the computer-readable medium 408 may be non-transitory or non-volatile medium, such as a magnetic disk or solid-state non-volatile memory or volatile medium such as RAM. The instructions or modules stored on the computer-readable medium 408 may include machine-readable instructions 412 executed by the processor(s) 402 that cause the processor(s) 402 to perform the methods and functions of the system 414.

The system 414 may be implemented as software stored on a non-transitory processor-readable medium and executed by the processors 402. For example, the computer-readable medium 408 may store an operating system 414, such as MAC OS, MS WINDOWS, UNIX, or LINUX, and code for the system 414. The operating system 414 may be multi-user, multiprocessing, multitasking, multithreading, real-time, and the like. For example, during runtime, the operating system 414 is running and the code for the system 414 is executed by the processor(s) 402.

The computer system 400 may include a data storage 416, which may include non-volatile data storage. The data storage 416 stores any data used or generated by the system 115. The network interface 406 connects the computer system 400 to internal systems, for example, via a LAN. Also, the network interface 406 may connect the computer system 400 to the Internet. For example, the computer system 400 may connect to web browsers and other external applications and systems via the network interface 406.

In some examples, the systems and methods described herein may include a method for implementing unlearning in large-language models (LLM) to enhance LLM performance, the method comprising accessing, by a processor, forget data samples from one or more datasets, associating, by the processor, a template response for each forget data sample via implementation of one or more LLMs, and training, by the processor, a target LLM using a forget data only loss adjustment (FLAT) function to generate an unlearned LLM, including implementing a loss adjustment to maximize a divergence for between an available template answer and a forget answer only with respect to forget data samples. In some examples, the method may include assigning, by the processor, importance weights for learning of template responses and forgetting of responses subject to unlearning, designating, by the processor, a first unlearning rate and a second unlearning rate, and maximizing, by the processor, a divergence for a first joint distribution and a second joint distribution.

Furthermore, in some examples, the systems and methods may include a non-transitory computer-readable storage medium having an executable stored thereon, which when executed instructs a processor to generate a forget data only loss adjustment (FLAT) function to provide a loss adjustment to maximize a divergence for between an available template answer and a forget answer only with respect to forget data samples, and train a target large language model (LLM) using the FLAT function to generate an unlearned LLM, including updating node content and embedding vectors of the target LLM. In some examples, the executable when executed further instructs the processor to access forget data samples from one or more datasets and associate a template response for each forget data sample via implementation of one or more LLMs, wherein the FLAT function is to assign importance weights for learning of template responses and forgetting of responses subject to unlearning, wherein the executable when executed further instructs the processor to generate exemplary responses for unlearned data samples, wherein the FLAT function is to disregard retain data or a reference LLM in implementing response calibration, wherein the executable when executed further instructs the processor to forget unlearned data samples with bad responses and generate good responses for unlearned data samples, wherein the executable when executed further instructs the processor to designate a first unlearning rate and a second unlearning rate. Also, in some examples, wherein training the target LLM using the FLAT function includes utilizing an unlearned data set.

In addition, the systems and methods described may provide a system comprising a processor and a memory communicably coupled to the processor, wherein the memory comprises processor-executable instructions which, when executed by the processor, cause the processor to retrieve data samples from one or more datasets via implementation of one or more LLMs, generate a forget data only loss adjustment (FLAT) function to maximize a divergence between a preferred template response and a forget response, and associate the FLAT function with a target large language model (LLM) to generate an unlearned LLM. In some examples, the processor is further to assign importance weights for learning of template responses and forgetting of responses subject to unlearning, maximize a divergence for a first joint distribution and a second joint distribution, and designate a first unlearning rate and a second unlearning rate, wherein training the target LLM using the FLAT function includes utilizing an unlearned data set.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in a generic classical processor system and a quantum computing system.

While this specification contains many specific implementation details, these should not be construed as limitations on the scope of what may be claimed, but rather as descriptions of features that may be specific to particular implementations. Certain features that are described in this specification in the context of separate implementations can also be implemented in combination with a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method for implementing unlearning in large-language models (LLM) to enhance LLM performance, the method comprising:
accessing, by a processor, forget data samples from one or more datasets;
associating, by the processor, a template response for each forget data sample via implementation of one or more LLMs; and
training, by the processor, a target LLM using a forget data only loss adjustment (FLAT) function to generate an unlearned LLM, including implementing a loss adjustment to maximize a divergence for between an available template answer and a forget answer only with respect to forget data samples.

2. The method according to claim 1, further comprising assigning, by the processor, importance weights for learning of template responses and forgetting of responses subject to unlearning.

3. The method according to claim 1, further comprising designating, by the processor, a first unlearning rate and a second unlearning rate.

4. The method according to claim 1, wherein the FLAT function is represented by:
$$L ( {x}_{f} , {y}_{e} , {y}_{f} ; θ ) = - [ {sup}_{g} ( g ( P ( {x}_{f} , {y}_{e} ; θ ) ) - {f}^{*} ( g ( P ( {x}_{f} , {y}_{f} ; θ ) ) ) ) ]$$
$$L ( {x}_{f} , {y}_{e} , {y}_{f} ; θ ) = - {g}^{*} ( P ( {x}_{f} , {y}_{e} ; θ ) ) + {f}^{*} ( {g}^{*} ( P ( {x}_{f} , {y}_{f} ; θ ) ) ) .$$

5. The method according to claim 1, further comprising maximizing, by the processor, a divergence for a first joint distribution and a second joint distribution.

6. A non-transitory computer-readable storage medium having an executable stored thereon, which when executed instructs a processor to:
generate a forget data only loss adjustment (FLAT) function to provide a loss adjustment to maximize a divergence for between an available template answer and a forget answer only with respect to forget data samples; and
train a target large language model (LLM) using the FLAT function to generate an unlearned LLM, including updating node content and embedding vectors of the target LLM.

7. The non-transitory computer-readable storage medium of claim 6, wherein the executable when executed further instructs the processor to access forget data samples from one or more datasets and associate a template response for each forget data sample via implementation of one or more LLMs.

8. The non-transitory computer-readable storage medium of claim 6, wherein the FLAT function is to assign importance weights for learning of template responses and forgetting of responses subject to unlearning.

9. The non-transitory computer-readable storage medium of claim 6, wherein the executable, when executed further instructs the processor to generate exemplary responses for unlearned data samples.

10. The non-transitory computer-readable storage medium of claim 9, wherein the FLAT function is to disregard retain data or a reference LLM in implementing response calibration.

11. The non-transitory computer-readable storage medium of claim 6, wherein the executable when executed further instructs the processor to forget unlearned data samples with bad responses and generate good responses for unlearned data samples.

12. The non-transitory computer-readable storage medium of claim 6, wherein the executable when executed further instructs the processor to designate a first unlearning rate and a second unlearning rate.

13. The non-transitory computer-readable storage medium of claim 6, wherein the executable when executed further instructs the processor to maximize a divergence for a first joint distribution and a second joint distribution.

14. The non-transitory computer-readable storage medium of claim 6, wherein training the target LLM using the FLAT function includes utilizing an unlearned data set.

15. A system comprising:
a processor; and
a memory communicably coupled to the processor, wherein the memory comprises processor-executable instructions which, when executed by the processor, cause the processor to:
retrieve data samples from one or more datasets via implementation of one or more LLMs;
generate a forget data only loss adjustment (FLAT) function to maximize a divergence between a preferred template response and a forget response; and
associate the FLAT function with a target large language model (LLM) to generate an unlearned LLM.

16. The system of claim 15, wherein the processor is further to assign importance weights for learning of template responses and forgetting of responses subject to unlearning.

17. The system of claim 15, wherein the FLAT function is represented by:
$$L ( {x}_{f} , {y}_{e} , {y}_{f} ; θ ) = - [ {sup}_{g} ( g ( P ( {x}_{f} , {y}_{e} ; θ ) ) - {f}^{*} ( g ( P ( {x}_{f} , {y}_{f} ; θ ) ) ) ) ]$$
$$L ( {x}_{f} , {y}_{e} , {y}_{f} ; θ ) = - {g}^{*} ( P ( {x}_{f} , {y}_{e} ; θ ) ) + {f}^{*} ( {g}^{*} ( P ( {x}_{f} , {y}_{f} ; θ ) ) ) .$$

18. The system of claim 15, wherein the processor is further to maximize a divergence for a first joint distribution and a second joint distribution.

19. The system of claim 15, wherein the processor is further to designate a first unlearning rate and a second unlearning rate.

20. The system of claim 15, wherein training the target LLM using the FLAT function includes utilizing an unlearned data set.
